(19) United States
(12) Patent Application Publication
(10) Pub. No.: US 2008/0231115 A1
(43) Pub. Date: Sep. 25, 2008

(54) Multiple-Output DC-DC Converter

(76) Inventors: Gyuha Cho, Daejeon (KR); Hanh Phuc Le, Hanoi (VN)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 11/687,036

(22) Filed: Mar. 16, 2007

(51) Int. Cl. H02J 1/00

(52) U.S. Cl. 307/41

(57) ABSTRACT

The invention relates to a DC/DC converter design. The converter requires only one single inductor to draw energy from one input source and distribute it to more than one outputs, employing Flexible-Order Power-Distributive Control (FOPDC). It include a single inductor, a number of power switches, comparators, only one error amplifier, a detecting circuit and a control block to regulate outputs. This converter can correctly regulate multiple outputs with fast transient response, low cross regulation, and effective switching frequency for each output. It can work in both discontinuous conduction mode (DCM) and continuous conduction mode (CCM). Moreover, with FOPDC, future output extension is simple, making a shorter time-to-market process for next versions of the converter. The design can be applied to different types of DC-DC converter.

### FIELD OF THE INVENTION

The invention relates to DC-DC switching converters, and more specifically, to single-inductor multiple-output DC-DC converters.

### BACKGROUND OF THE INVENTION

DC/DC switching converter is an indispensable part of many power management systems. As all designs are put into an effort of size reduction, converter cannot stay out of that trend. Designers, therefore, are exploring the way to shrink the size in both on-chip and off-chip implementation. Of all the approaches, Single-Inductor Multiple-Output (SIMO) converters come to prevail. With only one single inductor to regulate more than one output, the implementation can avoid problems that happen in conventional types of converters, such as too many bulky power devices as inductors, capacitors, and control ICs. Hence, the cost of mass-production is obviously much reduced. Single Inductor Multiple Output (SIMO) shows up as a most suitable and cost-effective solution in future development of DC-DC converter. However, it is still a big challenge to DC-DC converter designers because before the disclose of this invention, there is no proper control method that can be practical. That is the reason why there has been no SIMO switching DC-DC converter commercially sold on the market. Some approaches to Multiple Outputs converters are discussed in the following part of the invention.

In FIG. 1, a conventional existing commercial SIMO DC-DC converter is shown, but it is not a fully switching SIMO type. It consists of one inductor L, Boost converter 501, and Low-Drop-Output converters (LDOs) 502˜n. Inductor L with Boost converter 501 generates output Vo1 with the highest voltage, and all other outputs Vo2˜Von are generated by LDOs 502˜n, respectively. This structure has been widely used by many power-chip-making companies and proved fine functioning in real applications. It gives designers a simple way of implementation and a short time-to-market for a product with low ripple in LDO outputs. However, once the voltage difference between Vo1 and LDO outputs increases, efficiency decreases remarkably. This is because of the voltage drop over the series power transistor of LDOs. The loss over the power transistor becomes more serious when LDO output currents are increased in heavy loads. An effort to improve the performance of LDOs using a power transistor with larger size for high output current faces with chip area consumption which is not favorable in IC designs.

FIG. 2 and FIG. 3 show another conventional approach on SIMO switching DC-DC converters. The control scheme of the converter is Time-multiplexing. All outputs share the inductor and the main switch Sx, and each occupies a certain none-overlapped cycle and works as a separate boost converter. As shown in FIG. 3, in Φ1, inductor L, switch Sx and S1 work as a normal separated boost converter to transfer energy to Vo1. In Φ2, inductor L, switch Sx and S2 work as a normal separated boost converter to transfer energy to Vo2. In Φn, inductor L, switch Sx and Sn work as a normal separated boost converter to transfer energy to Von. The phases reserved for outputs are none-overlapped and controlled by the controller 600. In an effort to handle large output currents and suppress cross regulations, the converter is designed to work in pseudo-continuous or discontinuous conduction mode (PCCM/DCM). With PCCM, freewheel switch Sf is switched in both continuous conduction mode (CCM) and DCM to reduce loading effects from one to other outputs. That means, the freewheel switch Sf is turned on in any switching cycle at a determined level Idc, even the inductor current Idc is not zero, causing energy dissipation in the resistance of the inductor and the freewheel switch due to the none-zero inductor current during the freewheel time, The overall efficiency, therefore, is badly influenced, especially when the number of outputs increases. Moreover, the converter using PCCM has n separate proportional-integral (PI) control loops for n outputs, where each PI loop requires one error amplifier and one compensation network. It is clear that implementation of n compensation networks will be really bulky. That is not to mention a complex current sensing circuit for each output to make proper Idc level.

The drawbacks of the conventional techniques, therefore, urge the development of a new control method for multiple-output converter, which can reduce area consumption while maintaining good regulations for outputs. The converter using this method should also work properly in DCM and CCM. In additions, it is desirable to have a new method of simplicity and flexibility in implementation that can be applied to different converter types of multiple-output topologies for different application requirements.

### SUMMARY OF THE INVENTION

A multiple-output DC-DC converter is provided by the present invention which comprises an inductor for storing energy, a charging switch electrically connected in series with the inductor, a plurality of N output switches, wherein first ends of the output switches are connected to a node between the inductor and the charging switch and second end of each output switch is connected to a corresponding output terminal, wherein N is an integer of two or more, a detecting circuit for detecting current of the inductor and voltages of the output terminals, and a control circuit for sequentially controlling ON and OFF of the charging switch so as to store energy into the inductor, controlling ON and OFF of the first to N−1th output switches so as to distribute the energy to the corresponding output terminals, and controlling ON and OFF of the Nth output switch so as to distribute the energy to the corresponding output terminal.

According to an embodiment of the present invention, the control circuit of the multiple-output DC-DC converter may turns on the first to N−1th output switches simultaneously so as to distribute the energy to the corresponding output terminals.

According to an embodiment of the present invention, the control circuit of the multiple-output DC-DC converter may turns off the output switch when the voltage of the corresponding output terminal has reached a predetermined value.

According to an embodiment of the present invention, the control circuit of the multiple-output DC-DC converter may urns on the Nth output switch so as to distribute the energy to the corresponding output terminal when the each voltage of the first to N−1th output terminal has once reached a predetermined value.

According to an embodiment of the present invention, the multiple-output DC-DC converter may further comprise a freewheel switch electrically connected in parallel with the inductor, wherein the control circuit turns on the freewheel switch when the energy stored in the inductor is fully discharged.

According to an embodiment of the present invention the multiple-output DC-DC converter may further comprise a plurality of charging capacitors each electrically connected with the corresponding output terminals.

Also, a method of converting DC to DC is provided by the present invention which comprises the steps of (a) storing energy into a passive element, (b) distributing the stored energy to first to N−1th output terminals, and (c) distributing the stored energy to Nth output terminal after the step of (b), wherein N is an integer of two or more.

According to an embodiment of the present invention, the distribution of the stored energy to the first to N−1th output terminals may be simultaneously started.

According to an embodiment of the present invention, the distribution of the stored energy to the specific output terminal may be finished in case an amount of energy distributed to the output terminal has reached a predetermined value.

According to an embodiment of the present invention, the method of converting DC to DC may further comprise the step of (d) freewheeling the passive element when the energy stored in the passive element is fully discharged.

### BRIEF DESCRIPTION OF THE DRAWINGS

FIG. 1 diagrammatically illustrates a conventional method of SIMO converter with LDOs.

FIG. 2 diagrammatically illustrates a conventional method of SIMO converter with PCCM control.

FIG. 3 graphically illustrates the waveforms of real inductor current and timing diagram of the power switches of the converter shown in FIG. 2.

FIG. 4 diagrammatically illustrates the invented method of SIMO converter with Flexible Ordered Power-Distributive Control.

FIG. 5 graphically illustrates one possible timing diagram of the power switches of the converter shown in FIG. 4, where the output power switches are turned on one-by-one in a none-overlap pattern.

FIG. 6 graphically illustrates one possible timing diagram of the power switches of the converter shown in FIG. 4, where the power switches of the preceding outputs are turned on at the same time at the beginning of a discharge cycle and off separately by a signal from its correspondent comparator, and the power switch of the last output is turned on after all preceding output power switches are off.

FIG. 7 graphically illustrates one possible timing diagram of the power switches of the converter shown in FIG. 4, where the power switches of the preceding outputs are turned on in an overlap pattern and off separately by a signal from its correspondent comparator, and the power switch of the last output is turned on after all preceding output power switches are off.

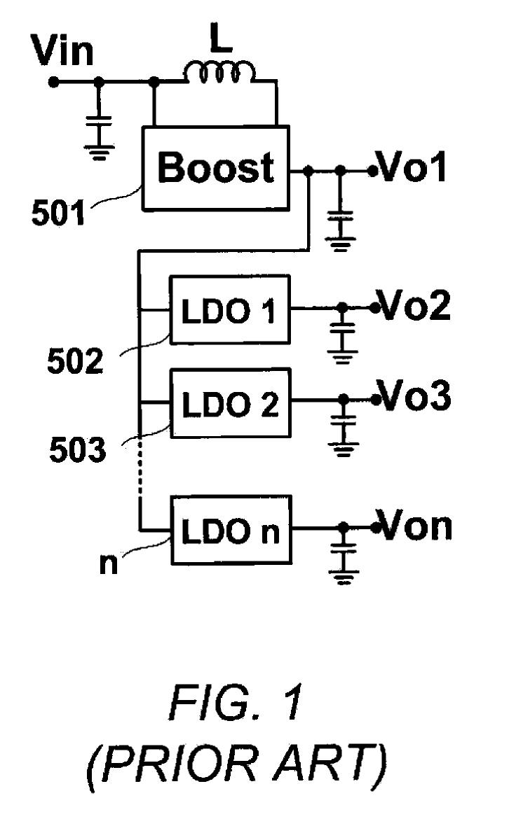

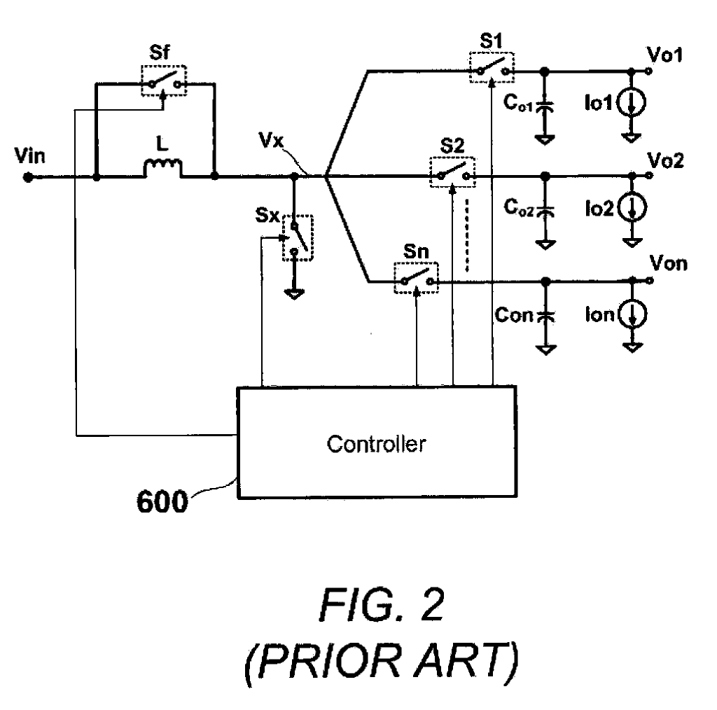

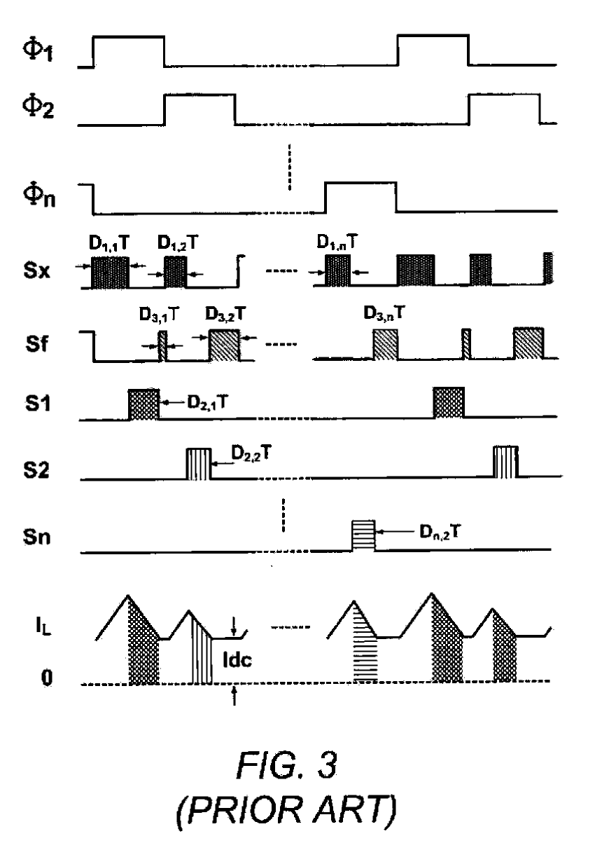

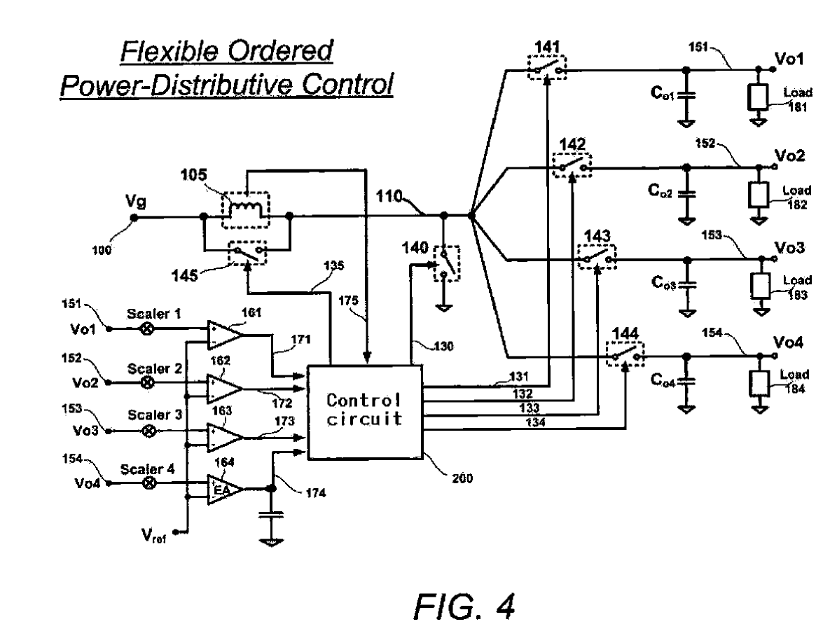

Each of FIG. 8-10 graphically illustrates one possible timing diagram of the power switches of the converter shown in FIG. 4.

### DETAILED DESCRIPTION OF THE PREFERRED EMBODIMENT

From now, the description disclosed in this invention will only be about a 4-output converter. The number 4 of outputs is chosen to imply the characteristic of multiple outputs. However, it is clear that the scope of this invention is not limited to 4-output converters. The number of output can be any integer of two or more, but a converter is still in the range of this invention if it uses the same control method of comparator(s) and one error amplifier.

A DC/DC switching power supply, which can power four positive outputs, includes one inductor 105, three comparators 161, 162, 163, and one error amplifier (EA) 164 in feedback loops, one control circuit, one inductor and six power switches (four output switches 141, 142, 143, 144; one main shared switch 140 and one freewheel switch 145). The three comparators 161, 162, and 163 are put in the feedback loops of the first three outputs to sense their voltage levels. The error amplifier 164, which is, usually but not limited, to one Operational Transconductance Amplifier (OTA), is put in the feedback loop of the last output to control the errors of all outputs, then, dependent on which, it decides the duty cycle of the main switch 140, or in fact, it decides the charge in the inductor 105. The power switches 141, 142, 143, and 144 are turned on and off in a certain order by Control Block 200 following the Flexible Ordered Power-Distributive Control to regulate outputs. The power switch 145 is to short the two terminals of the inductor L to the source, which is normally, but not limited to, a battery, to suppress possible ringing at node 110 when all the other power switches are off and the inductor 105's current is close to zero.

The Flexible Ordered Power-Distributive Control (FOPDC) sets one rule of order and control over all output that, in the discharge time of a cycle when the energy stored in the inductor is distributed to outputs, the output Vo4 has the last priority to receive energy and is controlled by PI control with an error amplifier (EA) in its feedback loop, while the other outputs have higher priority to receive first portions of energy and are controlled by comparators in their feedback loops, and are, thus, called bang-bang outputs. The preceding outputs Vo1, Vo2, and Vo3 can get energy one-by-one in none-overlap time sharing, or together in overlap time sharing as long as the output voltages are regulated by comparators. As it can be seen in this FOPDC, all of the errors of the preceding bang-bang outputs are transferred and accumulated to the last output Vo4, which is the only one requiring a compensation network in the feedback loop. Depending on the errors, the PI loop determines the duty cycle of the switch 140 to control the charge in the inductor 105.

The invention of FOPDC for SIMO converters helps regulate more than one DC outputs. The invention can be applied to different multiple output architectures, and different number of outputs. Of course, it can also work correctly in both CCM and DCM operations with the presence of the switch 145.

In this invention, various embodiments of the present invention will be described in detail with reference to the drawings, where like reference numerals and names represent like parts and appear throughout several views. Although the claimed invention is described with step-up converter, the scope of this invention is not limited to only step-up converters. A converter with FOPDC using one EA and n−1 comparators in feedback loops for n outputs is claimed to be within the scope of this invention.

A schematic diagram of the preferred embodiment of the multiple output boost converter is illustrated in FIG. 4. A positive terminal of an input power source 100 is connected to a first terminal of an inductor 105. A second terminal of the inductor 105 is connected to a charging switch 140. Four output switches 141, 142, 143 and 144 are provided in the converter. The first ends of all output switches 141, 142, 143 and 144 are connected to the node between the inductor 105 and the charging switch 140 and the second end of each output switches 141, 142, 143 and 144 is connected to the corresponding output terminals Vo1, Vo2, Vo3 and Vo4. A freewheel switch 145 is connected in parallel with the inductor 105. The freewheel switch 145 is active only in DCM mode. Charging capacitors Co1, Co2, Co3 and Co4 are coupled between the ground and the output terminals Vo1, Vo2, Vo3 and Vo4, respectively. Load 181, 182, 183 and 184 are coupled across capacitors Co1, Co2, Co3 and Co4, respectively.

A Control circuit 200 has output control lines 130, 131, 132, 133, 134, and 135 to turn on or off the switches 140, 141, 142, 143, 144 and 145, respectively. Also, a detecting circuit for detecting the current of the inductor and voltages of the output terminals Vo1, Vo2, Vo3 and Vo4 is provided in the converter. The Control circuit 200 has input inductor current signal 175 from the detecting circuit, input error signal 174 from EA 164, and input digital signal 171, 172, 173 from outputs of comparators 161, 162, 163, respectively. First inputs of the comparators 161, 162, 163 and EA 164 are connected, but not limited to, a reference voltage Vref. Voltage scalers Scaler 1, Sealer 2, Scaler 3, Scaler 4 are coupled between second inputs of the comparators 161, 162, 163, EA 164 and output lines 151, 152, 153 154 of Vo1, Vo2, Vo3, Vo4, respectively. Reference voltages for outputs can be from only one Vref, or different between outputs. The voltage scalers, together with the reference voltage (or the reference voltages), decide regulated output voltage levels.

In this invention of FOPDC, the output voltages Vo1, Vo2, and Vo3 are regulated with comparators while the last output Vo4 is regulated with EA 164. Outputs 171 (or 172, or 173) of the comparator 161 (or 162, or 163) changes its status, to HIGH in this drawing, to turn off switch 141 (or 142, or 143), when the output voltage Vo1 (or Vo2, or Vo3) reaches to the required voltage determined by the reference voltage Vref and voltage Scaler 1 (or Scaler 2, or Scaler 3). Since controlled by comparators, the output Vo1, Vo2 and Vo3 have very fast and robust responses. Moreover, they do not need compensation network in their feedback loops.

In the invention of FOPDC, the output voltage Vo4 is put as the last one and regulated by the error amplifier EA 164. In one switching cycle, or more correctly, in one energy distribution cycle, the output Vo4 is the last to receive charge from the inductor 105, when the other output Vo1, Vo2 and Vo3 are already at the required voltage. In other words to interpret the important points of the invention of FOPDC, the output which is regulated by error amplifier should be orderedly put as the last one to receive a portion of charge, when the other outputs already have enough charge. With the position as the last output to receive energy, Vo4 reflects the total energy needs of all the outputs. EA 164 integrates the voltage level of Vo4 every switching cycle to control the duty cycle (turn-on time) of the switch 140 to charge more or less energy to the inductor 105 in pulse with modulation (PWM) control. Therefore, the voltage loop of the last output Vo4 also takes the responsibility for total current charge in the inductor 105 every switching cycle.

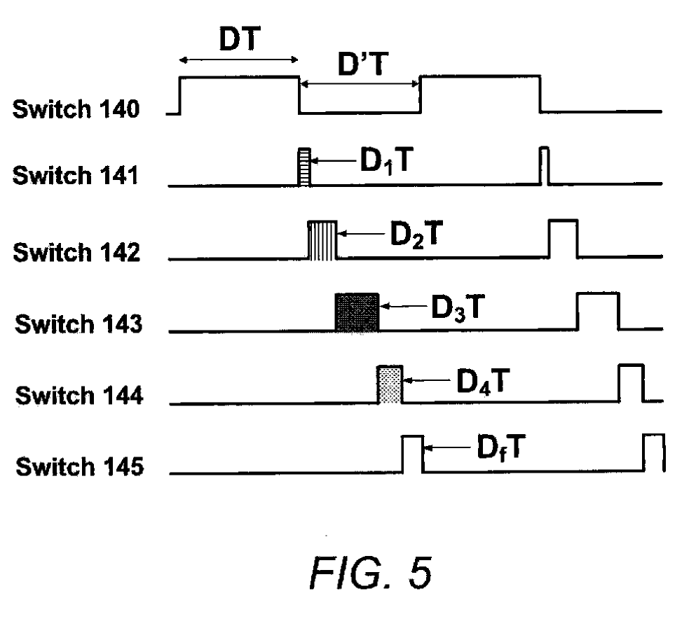

The invention of FOPDC with comparators and one error amplifier in the last output loop can be applied to different switching patterns. Some different exemplary switching patterns used to describe FOPDC are illustrated in FIGS. 5, 6, 7 and 8.

FIG. 5 will be described in relation with FIG. 4. In FIG. 5, during a charge cycle DT, the switch 140 is on and the inductor is charged. The time DT of PWM control is determined by the feedback loop of Vo4 with EA 164 and the Control circuit 200. The four output switches 141, 142, 143, 144 and the freewheel switch 145 (only active in DCM) share D′T to turn on. As mentioned in FOPDC, the outputs are arranged in the Control circuit 200 as Vo1, Vo2, Vo3, and Vo4 in descending order of priority to get energy. The capacitor Co1 of the output Vo1 gets the first portion of charge in D₁T when the switch 141 is turned on after the switch 140 is off. As soon as the portion of charge transferred to the capacitor Co1 makes Vo1 rise over its required voltage determined by its reference voltage and Voltage Scaler 1, making the comparator 161 change its output state, the line voltage 171 change to HIGH, the switch 141 is turned off by the output signal 131 from the Control circuit 200. Right after the switch 141 is off, the switch 142 of the output Vo2 is turned on in D₂T if Vo2 is detected by the comparator 162 to be smaller than its pre-determined voltage, and then, turned off at the end of D₂T when Vo2 goes over that pre-determined voltage. The switch 143 of Vo3, then, has the same operation with that of Vo2 and after Vo2. Then, the capacitor Co4 of Vo4 gets the last portion of charge. Dependent on the amount of the last portion, the EA 164 of Vo4 controls its voltage loop and the total current charge from the turn-on time (duty) of the switch 140 to make sure that the portion is enough to keep Vo4 at a pre-determined voltage while good regulation is already made in the preceding outputs. Before the start of a new switching cycle, if the charge stored in the inductor 105 is fully discharged to outputs, all the switches are turned off except for the switch 145 on during D_{f}T to suppress possible ringing at line 110. With the switch 145 in active mode, the converter is said to work in DCM operation. In CCM, since full discharge in the inductor 105 does not happen, the switch 145 is always off and D_{f}T does not exist in switching cycles.

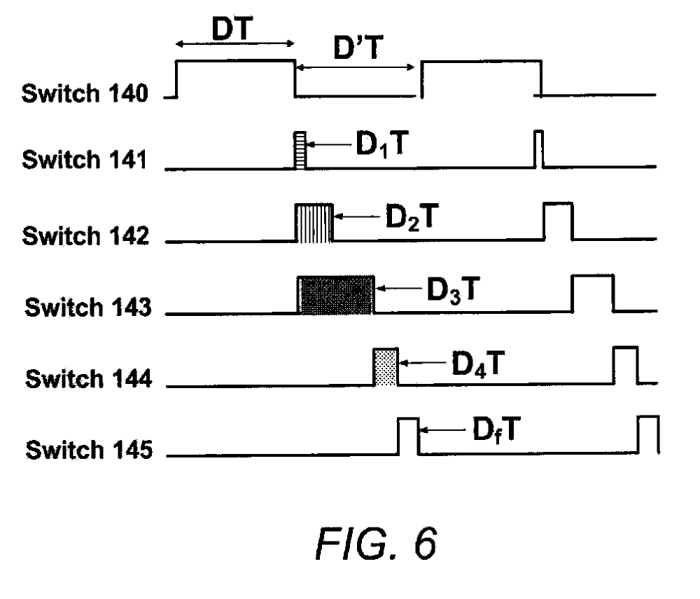

FIG. 6 will be described in relation with FIG. 4. In FIG. 6, during a charge cycle DT, the switch 140 is on and the inductor 105 is charged. The time DT of PWM control is determined by the feedback loop of Vo4 with EA 164 and the Control circuit 200. The four output switches 141, 142, 143, 144 and the freewheel switch 145 (active in DCM) share D′T to turn on. As mentioned in FOPDC, the outputs are arranged in the Control circuit 200 that Vo1, Vo2 and Vo3 have a priority over Vo4 to get energy. In this switching pattern, the Control circuit 200 arranges that the switches 141, 142 and 143 on together in the discharge cycle of a cycle. The capacitors Co1, Co2 and Co3 together share the first portion of energy from the inductor 105. Outputs 171, 172 and 173 of comparators 161, 162 and 163 change states to HIGH to turn off the switches 141, 142 and 143, respectively, when the outputs Vo1, Vo2, and Vo3 reach the required voltages pre-determined by the reference voltage and scalers. As soon as all the switches 141, 142 and 143 are off in a discharge cycle D′T, the switch 144 is turned on for the capacitor Co4 of Vo4 to get the last portion of charge. Also as mentioned in FOPDC, dependent on the amount of that portion, the EA 164 of Vo4 controls its voltage loop and the total current charge from the turn-on time (duty) of the switch 140 to make sure that the portion is enough to keep Vo4 at a pre-determined voltage while good regulation is already made in the preceding outputs. Before the start of a new switching cycle, if the charge stored in the inductor 105 is fully discharged to outputs, all the switches are turned off except for the switch 145 which is on during D_{f}T to suppress possible ringing at line 110. With the switch 145 in active mode, the converter is said to work in DCM operation. In CCM, since full discharge does not happen, the switch 145 is always off, and D_{f}T does not exist in switching cycles.

Compared with the switching pattern in FIG. 5, the switching pattern in FIG. 6 has some more advantages in operation. With the switching pattern in FIG. 6, difficulties in deadtime control between the on-states of the output switches 141, 142, 143, which are obvious in the pattern of FIG. 5, are eliminated. As designers all know, if deadtime controls are not exact, the voltage of line 110 does not change properly, causing efficiency reduction for the converter performance. In the switching pattern shown in FIG. 6, deadtime control for output switch 141, 142, and 143 are not necessary, thus, simplifying the design. Moreover, by turning on these three switches together, the charge, which is in form of current in the inductor 105, is shared simultaneously between the preceding outputs Vo1, Vo2, Vo3, reducing the peak current charged to each of them, so that the voltage ripples at output lines 151, 152, and 153 are reduced.

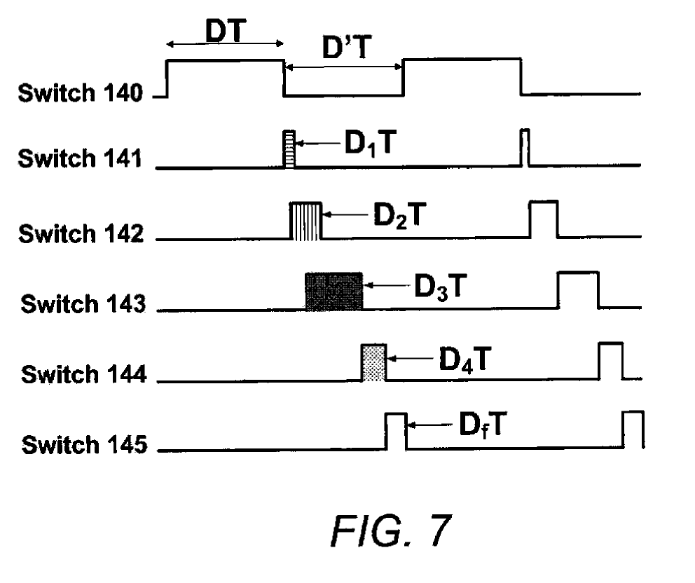

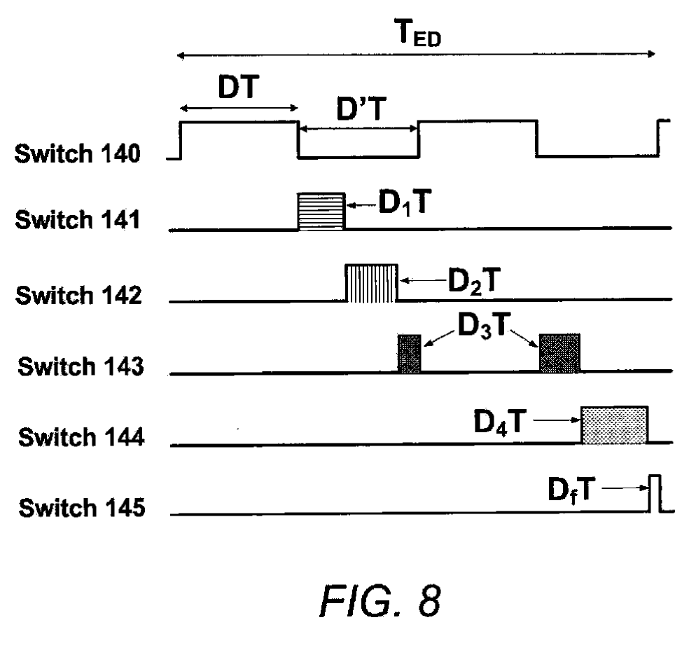

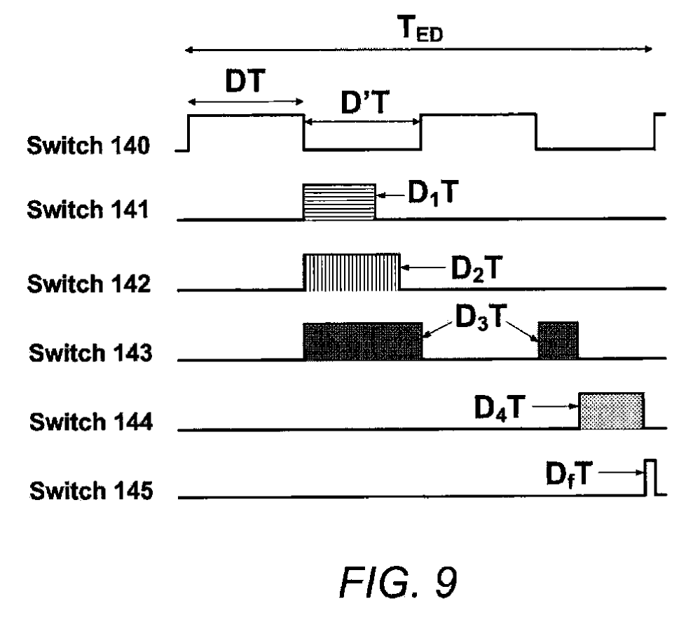

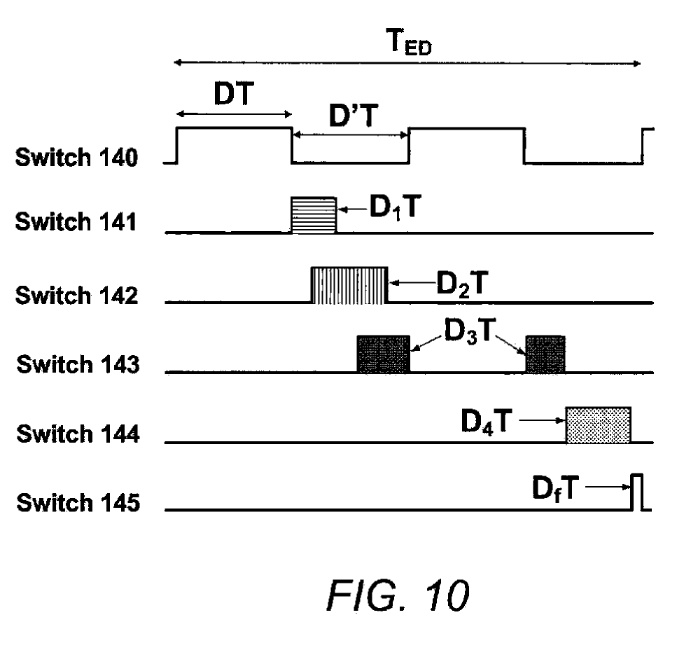

The switching pattern in FIG. 7 is the general view of that in FIGS. 5 and 6. The pattern shows that the switch 142 does not need to wait for off-state of the switch 141, and that the switch 143 does not need to wait for off-state of the switches 141 and 142, and that these output switches do not need to change from off to on-state together like in the pattern shown FIG. 6. Dependent on the arrangement of the Control circuit 200, two or three switches can be together on-state some period of time in the discharge cycle as long as each of them is still controlled with a signal from the feedback comparator (161, 162, or 163). While the order of charge transfer for the preceding output Vo1, Vo2 and Vo3 can be changed flexibly, the output Vo4 with EA 164 in its feedback loop always stays as the last to get charge.

The switching pattern in FIG. 7 also shares the advantages that were mentioned with the switching pattern in FIG. 6. In addition, the switching pattern in FIG. 7 gives designers the flexibility in designing on-state timings of the preceding output switches 141, 142 and 143. While the over-lap between on-states of the switches 141, 142 and 143 are available, the on-state timings can be designed, calculated, and controlled by the Control circuit 200 so that the maximum total efficiency for the converter is archieved. Therefore, the switching pattern in FIG. 7 is the general view of that in FIG. 5 and FIG. 6, but with more advantages to designers of SIMO converters and to the performance of SIMO converters themselves.

The switching patterns in FIG. 8, FIG. 9, and FIG. 10 are the general cases of those in FIG. 5, FIG. 6, and FIG. 7, respectively. To make it simple to understand, the above discriptions of this invention assume that the switching cycle T is identical with the energy distribution cycle T_{ED}. However, one energy distribution cycle T_{ED} is defined to include one or more than one switching cycle T that have one on-state of the switch 144. Therefore, in one energy distribution cycle, all output capacitors receive charge. Whereas, in one switching cycle, which is defined with one on-state of the switch 140, the number of output capacitors to get charge can be from one to four depending on the output voltage levels. In other words, in one switching cycle, the number of output switches to be on can be from one switch to all the four switches (141, 142, 143, 144). As mentioned above, the switch 145 is only active in DCM or at the boundary of DCM and CCM in FIG. 8, 9, 10. When it is always off-state, the converter is said to work in CCM operation.

What is claimed is:

1. A multiple-output DC-DC converter comprising:
an inductor for storing energy;
a charging switch electrically connected in series with the inductor;
a plurality of N output switches, wherein first ends of the output switches are connected to a node between the inductor and the charging switch and second end of each output switch is connected to a corresponding output terminal, wherein N is an integer of two or more;
a detecting circuit for detecting current of the inductor and voltages of the output terminals; and
a control circuit for, sequentially as following order, controlling ON and OFF of the charging switch so as to store energy into the inductor, controlling ON and OFF of the first to N−1th output switches so as to distribute the energy to the corresponding output terminals, and controlling ON and OFF of the Nth output switch so as to distribute the energy to the corresponding output terminal.

2. The multiple-output DC-DC converter of claim 1, wherein the control circuit turns on the first to N−1th output switches simultaneously so as to distribute the energy to the corresponding output terminals.

3. The multiple-output DC-DC converter of claim 1, wherein the control circuit turns off the output switch when the voltage of the corresponding output terminal has reached a predetermined value.

4. The multiple-output DC-DC converter of claim 1, wherein the control circuit turns on the Nth output switch so as to distribute the last portion of energy to the corresponding output terminal when the each voltage of the first to N−1th output terminal has once reached a predetermined value.

5. The multiple-output DC-DC converter of claim 1 further comprising:
a freewheel switch electrically connected in parallel with the inductor, wherein the control circuit turns on the freewheel switch when the energy stored in the inductor is fully discharged.

6. The multiple-output DC-DC converter of claim 1 further comprising:
a plurality of charging capacitors each electrically connected with the corresponding output terminals.

7. The multiple-output DC-DC converter of claim 1, wherein the detecting circuit comprising:
a plurality of comparators which compare the voltages of the first to N−1th output terminals with reference voltage; and
an error amplifier which integrates a difference between the voltage of the Nth output terminal and the reference voltage.

8. The multiple-output DC-DC converter of claim 7, wherein the detecting circuit further comprising:
a plurality of scalers which scale the voltages of the output terminals, wherein the comparators and the error amplifier compare the scaled voltages of the output terminals with the reference voltage.

9. The multiple-output DC-DC converter of claim 7, wherein the control circuit controls the ON and OFF of the first to Nth output switches sequentially so as to distribute the energy to the corresponding output terminals.

10. A method of converting DC to DC comprising the steps of:
(a) storing energy into a passive element;
(b) distributing the stored energy to first to N−1th output terminals; and
(c) distributing the stored energy to Nth output terminal after the step of (b), wherein N is an integer of two or more.

11. The method of converting DC to DC of claim 10, wherein the distribution of the stored energy to the first to N−1th output terminals is simultaneously started.

12. The method of converting DC to DC of claim 10, wherein the distribution of the stored energy to the specific output terminal is finished in case an amount of energy distributed to the output terminal has reached a predetermined value.

13. The method of converting DC to DC of claim 10 further comprising the step of:
(d) freewheeling the passive element when the energy stored in the passive element is discharged.
